(19) United States
(12) Patent Application Publication
(10) Pub. No.: US 2021/0033153 A1
(43) Pub. Date: Feb. 4, 2021

(54) CONSTANT VELOCITY JOINT

(71) Applicant: Gyrodata, Inc., Houston, TX (US)

(72) Inventor: James Edward KRAUS, Houston, TX (US)

(21) Appl. No.: 16/778,045

(22) Filed: Jan. 31, 2020

Related U.S. Application Data
(60) Provisional application No. 62/879,934, filed on Jul. 29, 2019.

(51) Int. Cl. F16D 3/84; F16D 3/33; F16D 3/38; F16C 3/02

(52) U.S. Cl. CPC F16D 3/843; F16C 3/02; F16D 3/385; F16D 3/33

(57) ABSTRACT

An implementation of the constant velocity (CV) joint may include a drive shaft and a housing. The drive shaft may include a first axis and a plurality of drive shaft lugs on a circumference of the drive shaft. Each of the plurality of drive shaft lugs may include a first surface having a first arcuate cross-section curved about a second axis and a second surface having a second arcuate cross-section that is curved about a third axis. The housing may include a third surface that is configured to contact the first surface to receive a rotational force from the drive shaft. The lug may define an elongate slit along a length of the lug.

### CROSS-REFERENCE TO RELATED APPLICATIONS

This application is a non-provisional application of and claims benefit to U.S. Provisional Application No. 62/879,934, filed Jul. 29, 2019, the entire contents of which are hereby incorporated by reference in their entirety.

### FIELD

The disclosure relates in general to transmission of torque between rotating components in downhole tools.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Downhole mud motors have internal parts that are used within the oil industry for earth boring operations. These mud motors rotate eccentrically internally. The eccentric rotation must be converted into concentric rotation in order for a drill bit to function correctly. The current state of the art generally accomplishes this conversion by providing a drive shaft having some type of constant velocity joint connection that connects the downhole motor to a drive assembly rotating the drill bit.

Traditional prior art constant velocity joints utilize ball bearings as drive elements for the transfer of forces between the rotor and drive shaft. More specifically, balls carried by the drive shaft engage recesses or slots formed in a female socket section so as to provide a point contact between surfaces. Another type of constant velocity joint utilizes meshing gear elements to transfer forces via line contact between the gear elements. More recently, one or more axially extending shoulders have been formed in a convexly spherical shaped bearing surface of a drive shaft, each shoulder having a surface disposed to engage a corresponding shoulder surface formed in the concavely spherical bearing surface of a female socket section of a rotor so as to transfer torque via the engaged shoulder surfaces. To facilitate this surface contact, an insert or “key” may be provided at a shoulder surface of a spherically shaped drive shaft end to minimize wear and galling of the shoulder surfaces.

However, it has been found that these surface contact constant velocity joints of the prior art, and in particular, the inserts, continue to exhibit damage from galling, shear compressive forces, and uneven or unequal loading.

### SUMMARY

Briefly, particular implementations of claimed subject matter may relate to a constant velocity (CV) joint for a mud motor.

In an implementation, a CV joint may include a drive shaft and a housing. The drive shaft my include a first axis and a plurality of drive shaft lugs on a circumference of the drive shaft. Each of the plurality of drive shaft lugs may include a first surface having a first arcuate cross-section curved about a second axis. Each of the plurality of drive shaft lugs may also include a second surface having a second arcuate cross-section that is curved about a third axis. The housing may include a third surface that is configured to contact the first surface to receive a rotational force from the drive shaft.

In a further implementation, a drive shaft for a CV joint may include a cylindrical shaft having a first axis, a distal end region and a lug on a circumference of the distal end region of the cylindrical shaft. The lug may include a first surface having a first arcuate cross-section curved about a second axis and a second surface having a second arcuate cross-section that is curved about a third axis.

In other implementations, a drive shaft for a CV joint may include a cylindrical shaft having a first axis, a distal end region and a lug on a circumference of the distal end region of the cylindrical shaft. The lug may define an elongate slit along a length of the lug. The lug may include a first surface having a first arcuate cross-section curved about a second axis and a second surface having a second arcuate cross-section that is curved about a third axis.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1A illustrates an implementation of a constant velocity joint;

FIG. 1B illustrates a cross-sectional view of the constant velocity joint of FIG. 1A;

FIG. 2A illustrates an exploded view of the constant velocity joint of FIG. 1A;

FIG. 2B illustrates a perspective view of a drive shaft and a housing;

FIG. 3A illustrates a perspective view of the drive shaft of FIG. 2B;

FIG. 3B illustrates a top view of the drive shaft of FIG. 2B;

FIG. 4A illustrates a perspective view of the housing of FIG. 2B;

FIG. 4B illustrates a top view of the housing of FIG. 2B;

FIG. 5 illustrates a further implementation of a drive shaft;

FIG. 6 illustrates a yet further implementation of a drive shaft;

FIG. 7A illustrates a further implementation of a constant velocity joint;

FIG. 7B illustrates a first alternate view of the constant velocity joint of FIG. 7A;

FIG. 7C illustrates a second alternate view of the constant velocity joint of FIG. 7A;

FIG. 8 illustrates a thrust pin; and

FIG. 9 illustrates a cross-sectional view of the implementation of FIGS. 7A-7C.

### DETAILED DESCRIPTION

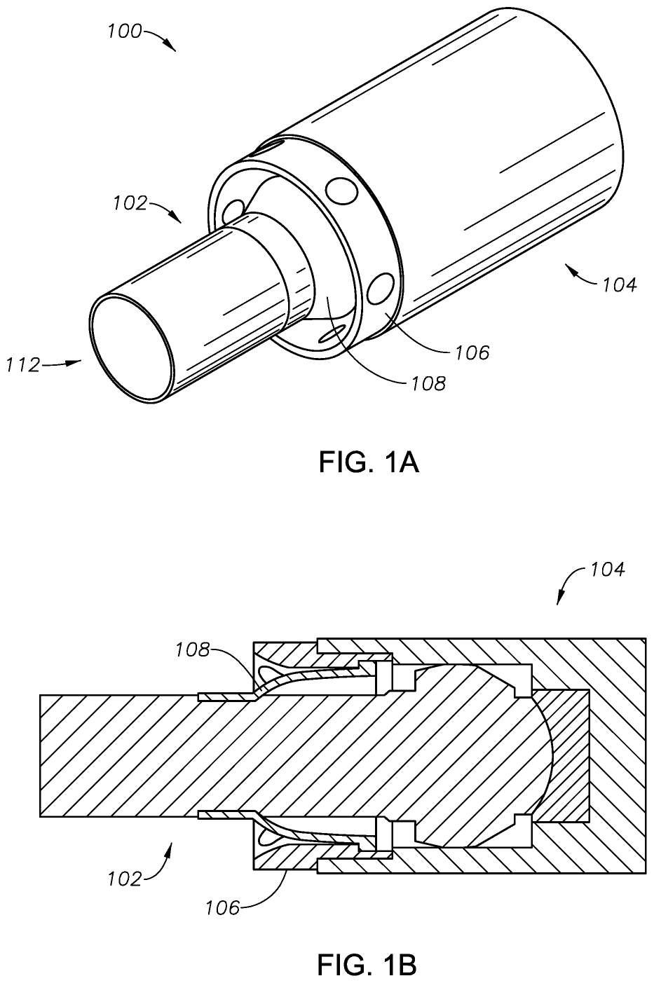

Various implementations described herein relate in general to transmission of torque between rotating components in downhole tools. More particularly, they relate to high torque constant velocity joints for drive shafts associated with downhole motors used in the oil and gas industry. Some of these will now be described in the following paragraphs with reference to FIGS. 1A-9.

FIGS. 1A and 1B illustrate a constant velocity (“CV”) joint 100. The CV joint 100 may include a drive shaft 102 and a housing 104. A CV cap 106 may be included on housing 104 and a boot 108 may be included on the drive shaft 102. The drive shaft 102 may be pivotally connected to the housing 104. Interaction between the drive shaft 102 and the housing 104 will be discussed below.

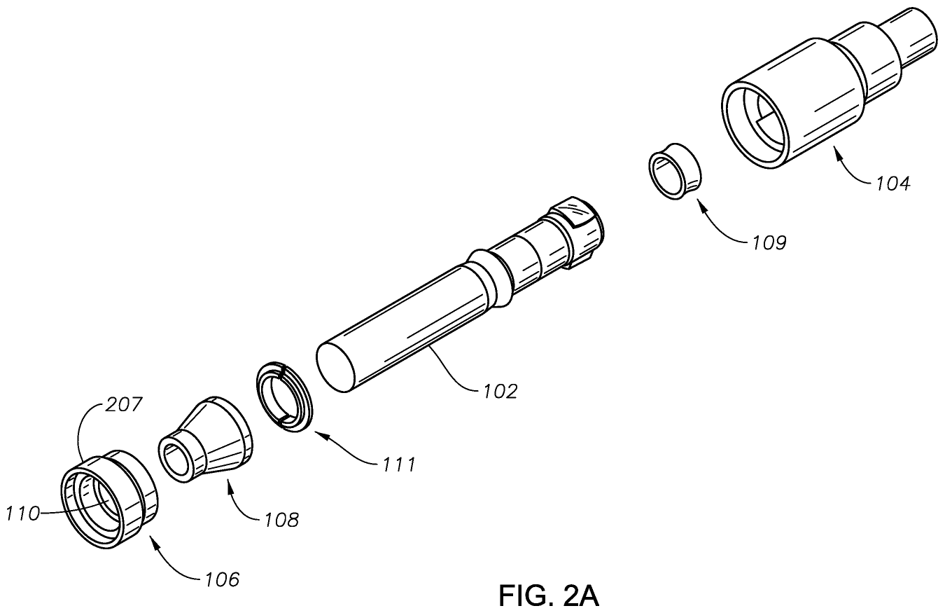

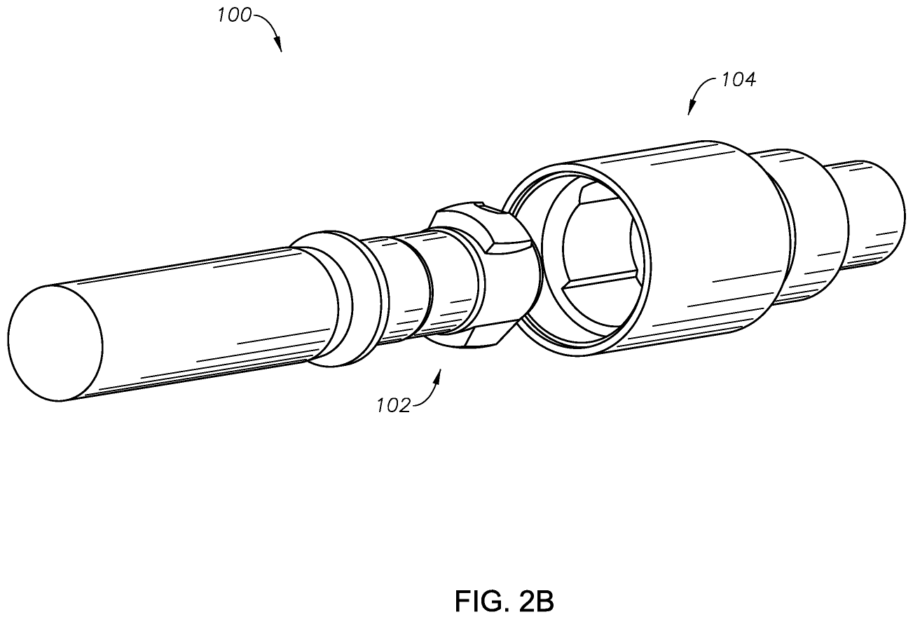

FIGS. 2A-2B illustrate an exploded view of the CV joint 100. The housing 104 is coupled to a bearing seat 109. The bearing seat 109 is further coupled to the drive shaft 102. The drive shaft 102 is coupled to a split ring 111. The split ring 111 is coupled to the boot 108. The CV cap 106 is coupled to the boot 108 and the housing 104.

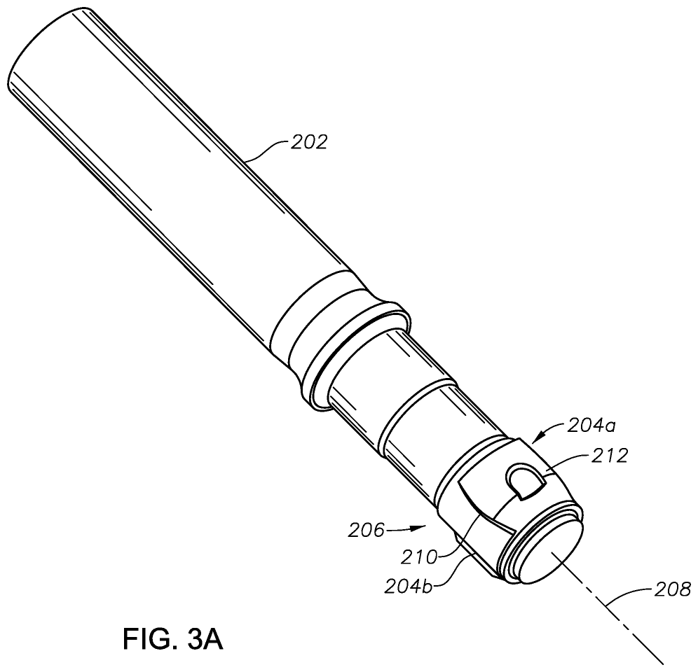

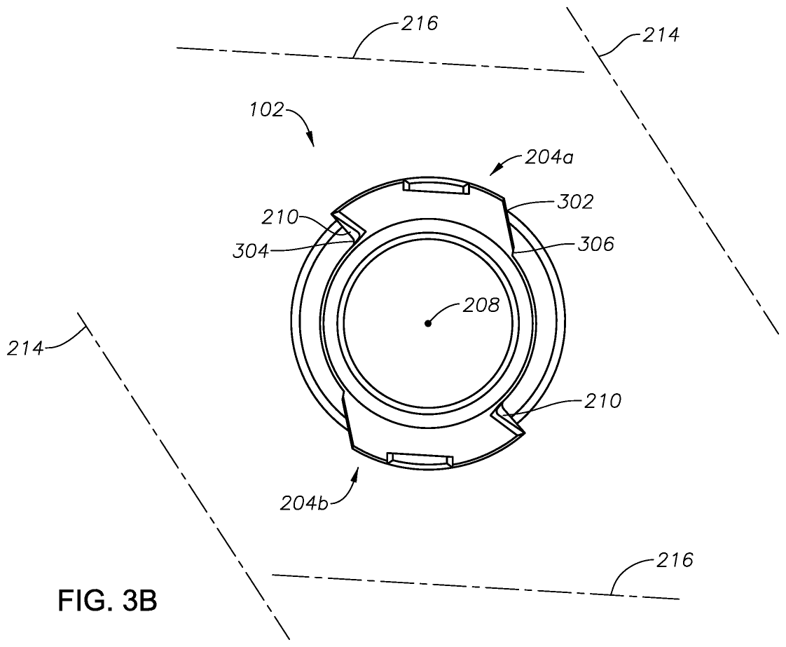

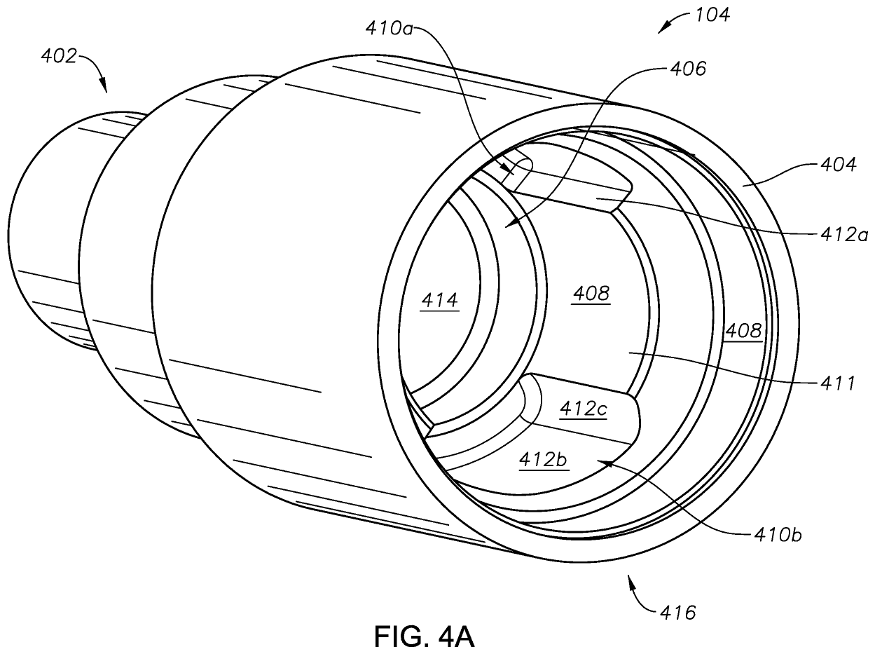

FIGS. 3A and 3B illustrate an implementation of the drive shaft 102. The drive shaft 102 may include a columnar shaft portion 202 and a first lug 204a on a distal end 206 of the columnar shaft portion 202. A second lug 204b may be included on the distal end 206 of the columnar shaft portion 202. The second lug 204b may be substantially diametrically opposed to the first lug 204a. The first lug 204a may have the same geometric configuration as the second lug 204b.

Further implementations may include additional lugs so that more than two total lugs are present on the joint—three total lugs, four total lugs, five total lugs, six total lugs, etc. may be present. The additional lugs may be on the distal end 206 of the columnar shaft portion 202 and/or may be on a proximal end (i.e., the end of the columnar shaft portion opposing the distal end 206) of the columnar shaft portion 202.

In some implementations, lugs may be on only the distal end of the drive shaft. In other implementations, lugs may be on the distal end of the drive shaft and also on the proximal end of the drive shaft. If lugs are included on both the proximal end and the distal end of the drive shaft, a secondary boot, a secondary split ring and a secondary cap may also be included in coordination with the distal end lugs.

The columnar shaft portion 202 may be cylindrical and the first lug 204a and the second lug 204b may be included on an exterior, e.g., circumferential, surface of the columnar shaft portion 202. The cylindrical geometry of the columnar shaft portion 202 may be about a shaft axis 208 (e.g., a first axis).

The first lug 204a may include at least one first surface 210 and a second surface 212. The first surface 210 may have a first arcuate cross-section and the second surface 212 may have a second arcuate cross-section. A curvature of the first arcuate cross-section may be about at least one second axis 214. A curvature of the second arcuate cross-section may be about at least one third axis 216 and about axis 208. The second axis 214 and the third axis 216 may both be perpendicular to the shaft axis 208.

The second axis 214 and the third axes 216 may be a center of a circle of which each arcuate cross-section may be an arc section. For example, if the arcuate cross-section were extended into a complete circle, the center of the circle would be the respective first or second axis.

FIG. 3B illustrates a top view of the distal end 206 of the drive shaft 102. A third surface 302 may be present on the lug 204a. The third surface 302 may be on a side of the lug 204a opposite the first surface 210. An edge 304 at which the first surface 210 contacts the columnar shaft portion 202 may be ninety degrees apart from an edge 306 at which the third surface 302 contacts the columnar shaft portion 202. With respect to a second lug 204b, the edge 304 may be one hundred and eighty degrees apart from a similar edge on the lug 204b. Similarly, the edge 306 may be one hundred and eighty degrees apart from a similar edge on the lug 204b.

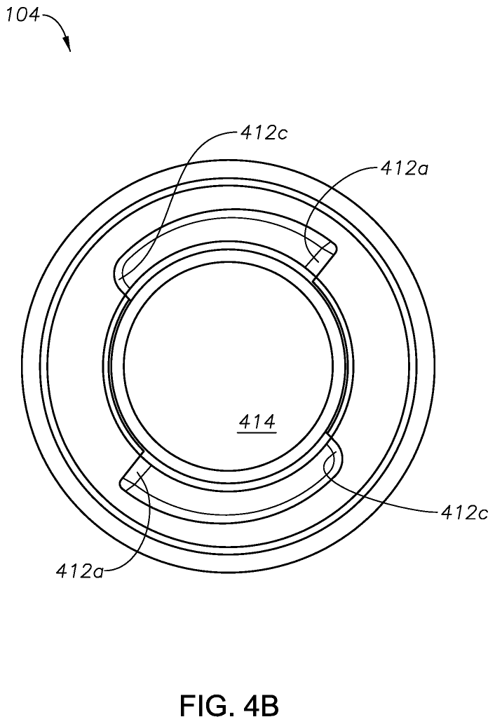

FIG. 4A illustrates the housing 104. The housing 104 may include a driven shaft 402 and a tubular portion 404 that defines a cavity 406. An interior surface 408 of the tubular portion 404 may define a first recess 410a. The interior surface 408 of the tubular portion 404 may also define a second recess 410b. A housing lug 411 may be between first defined recess 410a and second defined recess 410b. The first defined recess 410a may be substantially diametrically opposed to, e.g., one hundred and eighty degrees apart from, the second defined recess 410b. The first defined recess 410a may have the same geometric configuration as the second defined recess 410b. Further implementations may include additional defined recesses so that more than two total defined recesses are present—three total defined recess, four total defined recesses, five total defined recess, six total defined recess, etc. may be present. The additional defined recesses may be on the distal end of the driven shaft 402 and/or may be on a proximal end (i.e., the end of the driven shaft opposing the distal end) of the driven shaft 402.

The first defined recess 410a and the second defined recess 410b may include a plurality of surfaces. The plurality of surfaces may include the first recess surface 412a, e.g., the driven surface 412a, a second recess surface 412b and a third recess surface 412c. The first recess 410a may extend from a base 414 of the defined cavity 406 at least about half way toward a distal end 416 of the tubular portion 404.

FIG. 4B illustrates a top view of the housing 104. The first defined recess 410a may be substantially diametrically opposed to, e.g., one hundred and eighty degrees apart from, the second defined recess 410b. Therefore, the first surface 412a of the first defined recess 410a may also be diametrically opposed to an opposing first surface 412a (shown in FIG. 4B) of the second defined recess 410b. The first surface 412a may be between about sixty and about one hundred and ten degrees apart from the third surface 412c and separated by the second surface 412b (shown in FIG. 4A).

The housing 104 may be made of a softer material than the drive shaft 102. After an initial use of the CV joint, the housing 104 may thus change shape to conform to the shape of the lugs 204a and 204b. The drive shaft 102 and/or the housing 104 may be coated with a material that reduces friction between the drive shaft 102 and the housing 104. For example, implementations may include any abrasion resistant material or coating, wear resistant material or coating, shock absorbing material or coating, or heat treated material or coating.

With further reference to FIGS. 1A-1B, the drive shaft 102 engages the housing 104. The drive shaft 102 may be inserted into the housing 104. For example, the distal end 206 of the drive shaft 102 engages with the distal end 206 of the tubular portion 404 in a mated configuration.

The drive shaft 102 may be restrained in the housing 104 by the CV cap 106. For example, the CV cap 106 includes a ring portion 207 that defines through-hole 110 through which the drive shaft 102 passes. The CV cap 106 may be threaded for attaching to a mated thread portion (not shown) of the housing 104.

With reference to FIG. 1A, the boot 108 may engage the CV cap 106 and secure the boot 108 to the interior surface 408. The boot 108 may be rubber and may provide a seal for fluids, such as oil or grease, which is provided for engagement between the drive shaft 102 and the housing 104. The CV cap 106 may screw onto corresponding threads (not shown) of the housing 104. The through hole 110 may be large enough for the columnar shaft portion 202 to pass but not for the distal end 206 of the drive shaft 102 to pass.

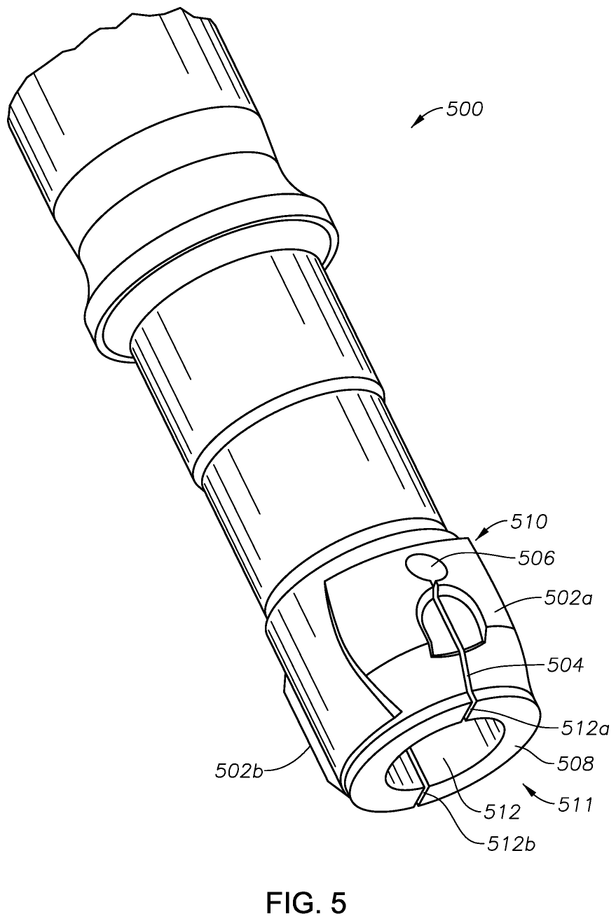

A further implementation of a drive shaft 500 of the CV joint is illustrated in FIG. 5. Features of the drive shaft 500 that are similar to the features of the drive shaft 102 are configured and operate similarly and therefore will not be discussed with further details here. The drive shaft 500 may include a first adjustable (or self-adjusting) lug 502a and second adjustable (or self-adjusting) lug 502b. The adjustable lugs 502a and 502b may include an elongate slit 504 in a central region of lugs 502a and/or 502b. The first adjustable lug 502a may have the same geometric configuration as the second adjustable lug 502b.

The adjustable lugs 502a and/or 502b may provide a rotational force equalization capability to the drive shaft 500. For example, if the first adjustable lug 502a engages a surface of the housing before the second adjustable lug 502b, the elongate slit 504 will narrow until the second adjustable lug 502b also engages the housing. Thus, both adjustable lugs 502a and 502b may nearly equally transfer rotational force from the drive shaft 500 to the housing.

A spring recess 506 may be provided at a proximal end region 510 of the adjustable lugs 502a and/or 502b. The spring recess 506 may be circular and may act as a stress reliever to reduce the amount of stress on a termination point of the elongate slit 504, if for example, the spring recess 506 were not present. The spring recess 506 may be defined by the lug and may have a circular cross-section that extends across the entire distal end of the drive shaft 500 from one adjustable lug 502a to another adjustable lug 502b.

The drive shaft 500 may include a drive shaft tube 508 at a distal end 511 of the drive shaft 500. The drive shaft tube 508 may include a first tube slit 512a and a second tube slit 512b. The drive shaft tube 508 may define a drive shaft tube recess 512. The first tube slit 512a may be positioned consistent with the elongate slit 504 of the first adjustable lug 502a. Similarly, the second tube slit 512b may be positioned consistent with the second adjustable lug 502b. Thus, drive shaft tube 508 may be adjustable consistent with the lugs 502a and 502b.

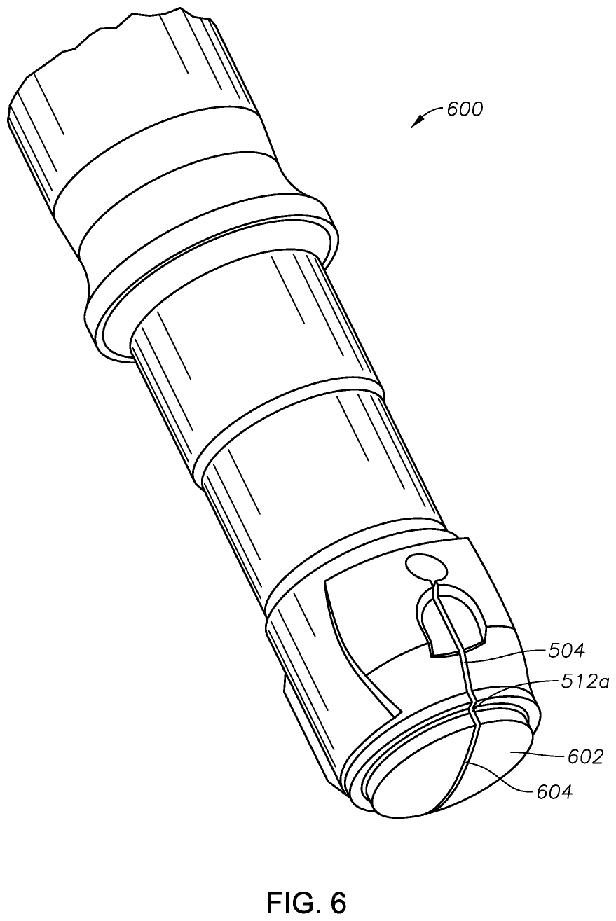

A yet further implementation of a drive shaft 600 is illustrated in FIG. 6. Features of the drive shaft 600 that are similar to the features of the drive shaft 102 and the drive shaft 500 are configured and operate similarly and therefore will not be discussed with further details here. The drive shaft 600 may include a thrust bearing 602. The thrust bearing 602 may be in the defined drive shaft tube recess 512. In one implementation, the thrust bearing 602 may engage the drive shaft tube recess 512 via an interference fit and/or adhesive. In another implementation, the thrust bearing 602 may be integral to the drive shaft tube 508.

The thrust bearing 602 may be spherical and may include a thrust bearing slit 604 bisecting a circular cross-section of the thrust bearing 602. The thrust bearing slit 604 may be positioned consistent with the elongate slit 504 of the first adjustable lug 502a, the first tube slit 512a, the second tube slit 512b and the elongate slit of the second adjustable lug 504b. Thus, thrust bearing 602 may be adjustable consistent with the lugs 502a and 502b.

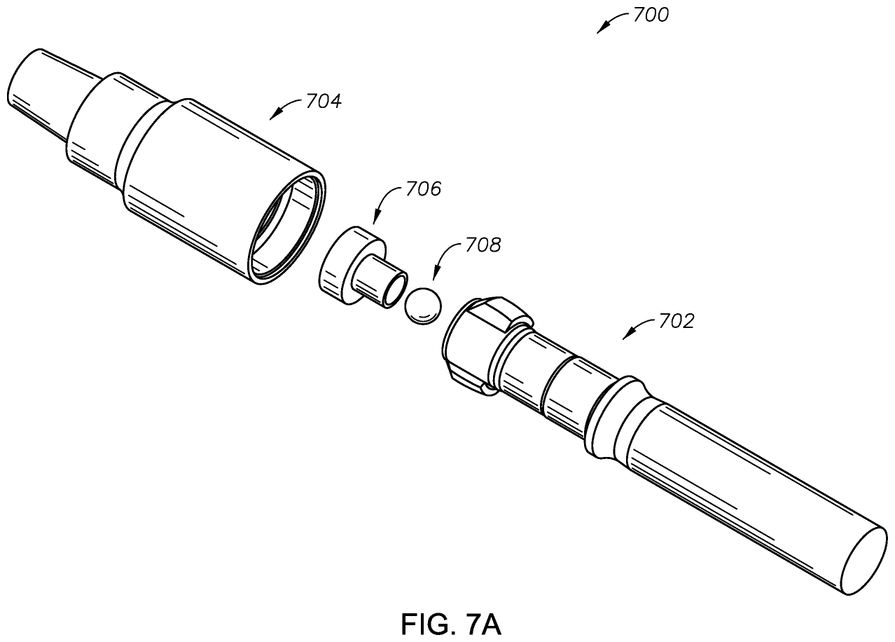

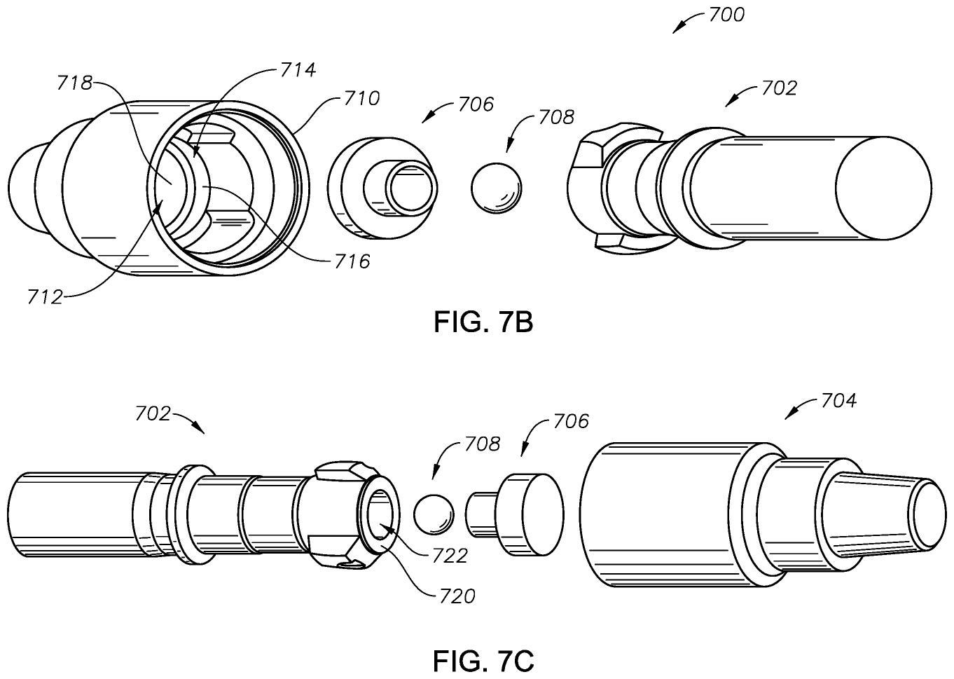

A further implementation of a constant velocity (CV) joint 700 is illustrated in FIGS. 7A-7C. Features of the CV joint 700 that are similar to the features of the CV joint 100 are configured and operate similarly and therefore will not be discussed with further detail here. As illustrated in FIG. 7A, the CV joint 700 may include a drive shaft 702, a housing 704, a thrust pin 706 (i.e., a bearing pin) and a ball bearing 708 (i.e., a bearing pin ball bearing).

As illustrated in FIG. 7B, the housing 704 may include a housing tubular portion 710. The housing tubular portion 710 may define a cavity 712. The defined cavity 712 may include a seat section 714. The seat section 714 may include a seat ring 716 and a seat base 718. At least a portion of the thrust pin 706 may sit within the seat section 714 against the seat base 718. The thrust pin 706 may fit loosely within the seat section, e.g., the thrust pin 706 may have allowable axial and/or lateral displacement.

Alternatively, the thrust pin 706 may fit snugly in the seat section 714 so that axial and/or lateral displacement is reduced or prevented. Thus, the seat ring 716 may prevent axial and lateral displacement. For example, the seat ring 716 may have an interference fit with the thrust pin 706 or the seat ring 716 may be connected to the thrust pin 706 via a threaded connection or an adhesive.

As illustrated in FIG. 7C, the drive shaft 702 may include a drive shaft tubular portion 720. The drive shaft tubular portion 720 may define a drive shaft cavity 722. The drive shaft cavity 722 may receive the ball bearing 708 and at least a portion of the thrust pin 706. The drive shaft cavity 722 may be large enough to allow about ten degrees of angular deflection, i.e., tilt, of the thrust pin 706 relative to a longitudinal axis (a centerline) of the drive shaft 702.

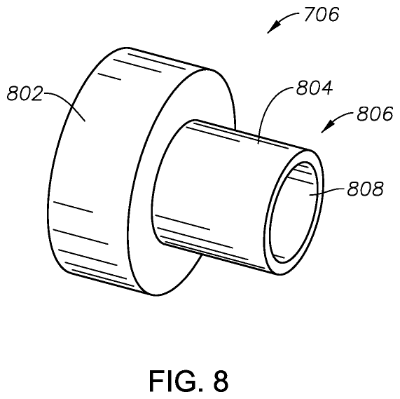

FIG. 8 illustrates the thrust pin 706. The thrust pin 706 may include a thrust pin collar 802, and a thrust pin cylinder 804. The thrust pin cylinder 804 may be attached by a planar base of the thrust pin collar 802 to a central portion of the thrust pin collar 802. A free end 806 of the thrust pin cylinder 804 may define a thrust pin recess 808. The thrust pin recess 808 may be concave or spherical. The thrust pin recess 808 may at least partially receive the ball bearing 708.

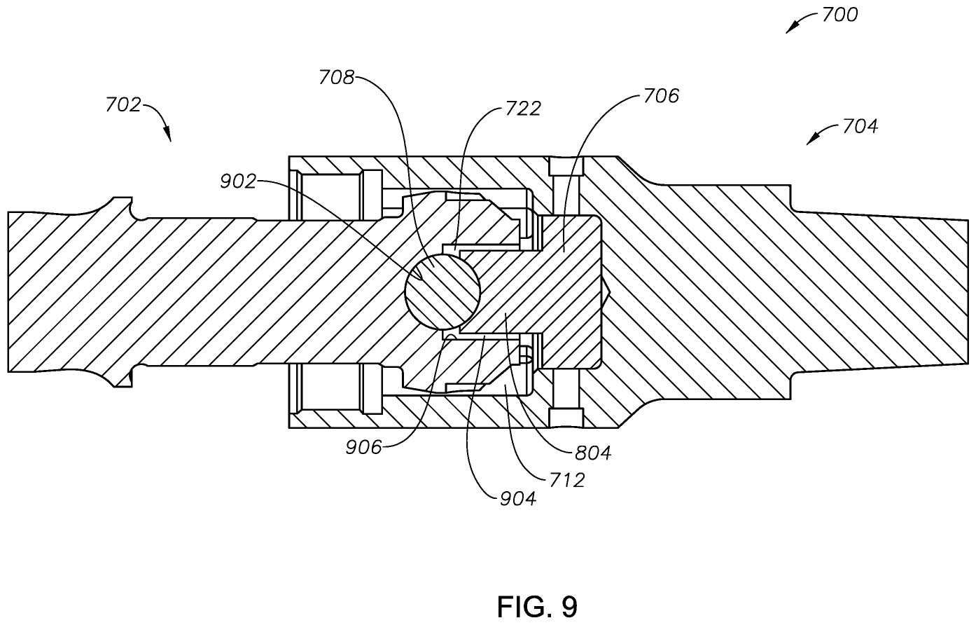

FIG. 9 illustrates a cross-sectional view of the CV joint 700. A distal end of the drive shaft may be within the defined cavity 712 of the housing 704. The drive shaft 702 engages the housing 704 via the thrust pin 706. The thrust pin 706 engages the ball bearing 708 which engages a base 902 of the drive shaft cavity 722. A tolerance 904 is provided between the thrust pin cylinder 804 and a wall 906 of the drive shaft cavity 722. The tolerance 904 between the thrust pin cylinder 804 and the wall 906 of the drive shaft cavity 722 may allow the thrust pin cylinder 804, e.g., the pin, and, therefore, the combined thrust pin 706 and the housing 704, to tilt at as much as about ten degrees relative to a centerline of the drive shaft 702.

In operation, rotational force, e.g., torque, may be transferred from the drive shaft 102 to the housing 104 via engagement between the drive shaft 102 and the housing 104. The drive shaft 102 may rotate in response to an input at a proximal end 112 of the drive shaft 102. For example, the first lug 204a may tangentially engage the first defined recess 410a. The first lug 204a may also be considered to contact the housing lug 411, which may be one of a plurality of housing lugs, as the housing lug terminates at the defined recesses. Similarly, the second lug 204b may engage the second defined recess 410b such that rotational force can be transferred from the first lug 204a to the first defined recess 410a and/or from the second lug 410b to the second defined recess 410b equally.

Rotational force may be transferred from the first surface 210 of the first lug 204a and/or the second lug 204b to the first surface 412a of the defined recess 410a and/or 410b. Rotational force may be transferred from the drive shaft 102 to the housing 104 regardless of the angle between the drive shaft 102 and the housing 104. For example, the drive shaft 102 does not have to be at zero degrees relative to the housing 104. The drive shaft 102 may have a non-zero degree engagement with the housing 104. Irrespective of the angle between the drive shaft 102 and the housing 104, there is no loss of angular velocity between the drive shaft 102 and the housing 104. In some implementations, the constant velocity joint may work in reverse, e.g., the drive shaft 102 may act as the driven shaft and the housing 104 may act as a drive shaft.

Reference is made in the foregoing detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others.

Example implementations are provided so that this disclosure will be thorough, and will fully convey the scope to those who are skilled in the art. Numerous specific details are set forth such as examples of specific components, devices, and methods, to provide a thorough understanding of implementations of the present disclosure. It will be apparent to those skilled in the art that specific details need not be employed, that example implementations may be embodied in many different forms and that neither should be construed to limit the scope of the disclosure. In some example implementations, well-known processes, well-known device structures, and well-known technologies are not described in detail.

The terminology used herein is for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example implementations.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Further, it is to be understood that other implementations may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict the scope of claimed subject matter. Therefore, the foregoing detailed description is not to be taken to limit claimed subject matter and/or equivalents.

Although illustrative implementations of claimed subject matter have been described in detail herein with reference to the accompanying drawings, it is to be understood that the invention is not limited to those precise implementations, and that various changes, additions and modifications can be effected therein by one skilled in the art without departing from the scope of the invention as defined by the appended claims. For example, various combinations of the features of the dependent claims could be made with the features of the independent claims without departing from the scope of claimed subject matter.

What is claimed is:

1. A constant velocity (CV) joint, comprising:
a drive shaft having:
a first axis; and
a plurality of drive shaft lugs on a circumference of the drive shaft, wherein each of the plurality of drive shaft lugs comprises a first surface having a first arcuate cross-section curved about a second axis and a second surface having a second arcuate cross-section that is curved about a third axis; and
a housing including a third surface that is configured to contact the first surface to receive a rotational force from the drive shaft.

2. The CV joint of claim 1, wherein the second axis is substantially perpendicular to the first axis, the first axis being an elongate axis of the drive shaft.

3. The CV joint of claim 2, wherein the third axis is substantially perpendicular to the first axis.

4. The CV joint of claim 1,
wherein the housing further includes one or more housing lugs configured to tangentially contact the drive shaft lugs, and
wherein at least one of the one or more housing lugs includes the third surface.

5. The CV joint of claim 4, wherein the one or more drive shaft lugs include a harder material than the one or more housing lugs.

6. The CV joint of claim 1 further comprising:
at least one lug recess in the one or more of the plurality of drive shaft lugs, the at least one lug recess being an elongate slit.

7. The CV joint of claim 6, wherein the at least one lug recess is in a distal end region of the drive shaft.

8. The CV joint of claim 7, wherein the at least one lug recess substantially bisects the distal end region of the drive shaft.

9. The CV joint of claim 7, wherein the distal end region includes a tube that defines a tubular cavity that is coaxial with a first axis, the first axis being an elongate axis of the drive shaft.

10. The CV joint of claim 9, further comprising:
a thrust bearing in the defined tubular cavity, the thrust bearing including a thrust bearing recess substantially collinear with the at least one lug recess.

11. The CV joint of claim 1 further comprising:
a bearing pin ball bearing; and
a bearing pin in the distal end region of the drive shaft, the thrust pin and the drive shaft both being coupled to the thrust pin ball bearing.

12. A drive shaft for a constant velocity (CV) joint comprising:
a cylindrical shaft having a first axis and a distal end region; and
a lug on a circumference of the distal end region of the cylindrical shaft, wherein the lug includes:
a first surface having a first arcuate cross-section curved about a second axis, and
a second surface having a second arcuate cross-section that is curved about a third axis.

13. The drive shaft of claim 12, wherein the second axis is substantially perpendicular to the first axis, the first axis being an elongate axis of the drive shaft.

14. The drive shaft of claim 13, wherein the third axis is substantially perpendicular to the first axis.

15. The drive shaft of claim 12, further comprising:
at least one lug recess in the one or more of the plurality of drive shaft lugs, the at least one lug recess being an elongate slit.

16. The drive shaft of claim 15, wherein the at least one lug recess is in the distal end region of the drive shaft.

17. The drive shaft of claim 16, wherein the at least one lug recess substantially bisects the distal end region of the drive shaft.

18. The drive shaft of claim 16, wherein the distal end region includes a tube that defines a tubular cavity that is coaxial with a first axis, the first axis being an elongate axis of the drive shaft.

19. The drive shaft as recited in claim 18, further comprising:
a thrust bearing in the defined tubular cavity and wherein the thrust bearing includes a thrust bearing recess substantially collinear with the at least one lug recess.

20. The drive shaft of claim 12 further comprising:
a thrust pin ball bearing; and
a thrust pin in the distal end region of the drive shaft, the thrust pin and the drive shaft both being coupled to the thrust pin ball bearing.

21. A drive shaft for a constant velocity (CV) joint comprising:
a cylindrical shaft having a first axis and a distal end region; and
a lug on a circumference of the distal end region of the cylindrical shaft, wherein the lug defines an elongate slit along a length of the lug and includes:
a first surface having a first arcuate cross-section curved about a second axis, and
a second surface having a second arcuate cross-section that is curved about a third axis.

22. The drive shaft as recited in claim 21,
wherein the distal end region includes a tube that defines a tubular cavity that is coaxial with the first axis, the first axis being an elongate axis of the cylindrical shaft; and
wherein the drive shaft further comprises a thrust bearing in the defined tubular cavity, the thrust bearing including a thrust bearing slit.

23. The drive shaft of claim 21 further comprising:
a thrust pin ball bearing; and
a thrust pin in the distal end region of the drive shaft, the thrust pin and the drive shaft both being coupled to the thrust pin ball bearing.
